(19) United States
(12) Patent Application Publication
(10) Pub. No.: US 2008/0104067 A1
(43) Pub. Date: May 1, 2008

(54) LOCATION BASED LARGE FORMAT DOCUMENT DISPLAY

(75) Inventors: Dean E. Thorson, Grayslake, IL (US); William P. Alberth, Prairie Grove, IL (US); Daniel J. Declerck, Lake Barrington, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/553,744

(22) Filed: Oct. 27, 2006

(51) Int. Cl. G06F 17/30; G06F 17/00

(52) U.S. Cl. 707/6; 707/1; 715/273

(57) ABSTRACT

A method (203) for using electronic large format location dependent documents can include the steps of determining (200) a location of a remote user terminal (110) and accessing (210) at a server a document database having document information related to the plurality of documents. The document information includes at least one physical location associated with each document and the method further includes the step of searching (220) the document database and generating (230) a list of matching documents. The list of matching documents includes an identification of each one of the plurality of documents having an associated physical location substantially matching the determined location of the remote user terminal. The method can further retrieve (250) a selected document from the mass storage device system and display (260) the selected document on a large format display (105) coupled to the remote user terminal.

### FIELD

This invention relates generally to mobile devices, and more particularly to a system and methods for electronically displaying and using large format documents based on the location of a mobile large format display.

### BACKGROUND

As mobile devices have become more advanced by incorporating an ever increasing number of features, the tendency has been to reduce the size of such devices, usually to a handheld size. However, even though users desire a handheld device for many recreational and business applications, there are still some activities in which it is preferable to display information in a large format size. As such, the small displays incorporated into handheld devices or even laptop computers are insufficient for such applications.

Display of large format documents is often desired because sometimes it is necessary to see large amounts of related information in a single view. In a first example, the construction and trade industries, rescue services, and law enforcement often use blueprints or other architectural drawings as a common method of information exchange. While such drawings could be shown on much smaller displays, the amount of detail necessary for the viewer to comprehend and use the information effective often requires a larger display. In a second example, large maps are also often used as a common method of information exchange or travel planning by individuals and businesses alike. In a third example, large posters and banners are also often used to convey information to large groups of people.

Traditionally, portable large format documents are rolled up and placed into tubes, folded up and placed into a box or envelope, or stored at the location where they are to be used. The result is often damaged documents, a direct result of the wear and tear associated with the handling of the documents. Another result is often the misplacing of documents, resulting in wasted time and resources in searching for, retrieving, or replacing such large documents. A solution to the management of large format documents has been the advent of the computer devices and associated storage devices. Such devices are capable of storing vast amounts of data, including large format documents, and allow efficient access to them. An example is U.S. Pat. No. 5,526,520, issued Jun. 11, 1996 to Krause, which describes a computer based system for processing and organizing building plans. However, such systems are generally limited for use on small user screens, as sufficiently large screens are typically difficult to transport and use for such applications. However, with the advent of large flexible display systems, it is now possible to transport such large format documents. An example is U.S. Patent Application No. 2005/0040962 to Funkhouser et al., which describes a large portable flexible display system capable of displaying and manipulating large documents such as architectural plans and drawings.

However, while such systems provide access to multiple large format documents, they are still limited in many respects. First, users must still input search parameters in order to retrieve and to display the document. This can result in error if the proper document is not chosen, especially when handling a number of similar but distinct documents. Second, although a unique identifier could be associated with a document, a user may not always have access to the list of unique identifiers or be unable to recall or locate the unique identifier. Finally, a more complex user interface is typically required to efficiently enter the search parameters or unique identifier to locate a document. Therefore such systems do not provide a way to automate the search process or simplify the user interface.

Simpler user interfaces are known only in limited applications. For example, in the case of maps, it is generally known that consumer global positioning system (GPS) devices coupled to a map database are capable of showing the real-time location of the device on a map or even the location of other nearby objects on a map. In such applications, a simple user interface can be provided since the user is generally only interested in finding a location and does not need to make changes to the map with any type of frequency. However, such devices only provide limited information and graphical details, as such devices are generally limited to smaller portable devices having small displays.

### SUMMARY OF THE INVENTION

Embodiments in accordance with the present invention can provide a large format document display system and methods that provide for automatic display and/or selection of document based on the location of the display. Large format displays are large displays that can display blueprints, construction plans, architectural drawings or other documents as contemplated herein.

In a first embodiment of the invention, a method for using electronic large format location dependent documents includes the steps of determining a location of a remote user terminal (such as any wireless communication device capable of providing data), and accessing a mass storage system (such as any storage medium capable of storing the documents contemplated herein) using the remote user terminal where one or more documents are stored in the mass storage system and at least one physical location is associated with each one of the stored documents. The method further includes the step of generating a list of matching documents where the list of matching documents includes an identification of the stored documents stored having at least one physical location substantially matching the determined location of the remote user terminal and further retrieving a selected document from the mass storage system and displaying the selected document on a large format display (such as a flexible display device) coupled to the remote user terminal. The selected document is selected from the generated list of matching documents. The method can further include the step of updating the location of the remote user terminal and repeating the steps of accessing, generating, retrieving, and displaying if the location of the remote terminal device has substantially changed. Note, revision information can be associated with each one of the stored documents and the method can further include the step of accessing the mass storage system, retrieving and analyzing revision information associated with the selected document, and updating the displayed selected document if revision information associated with the displayed selected document has changed. The method can further update by providing indicia to identify at least one updated portion of the displayed selected document. Note, the mass storage system can further include at least one local mass storage device coupled to the remote user terminal and at least one remote mass storage device accessible by the remote user terminal. The documents contemplated herein can include blueprints, construction plans, or other architectural drawings as examples.

In a second embodiment of the invention, a system for using electronic large format location dependent documents can include, a remote user terminal (such as a wireless communication device) having access to a mass storage system where the remote user terminal has a positioning device that determines a location of the remote user terminal and where the mass storage system has stored therein one or more documents where the stored documents have associated document information and the document information includes at least one physical location associated with each one of the stored documents, and a large format display (such as a flexible display device) coupled to the remote user terminal. The remote user terminal accesses the mass storage system, reads the document information, generates a list of matching documents, retrieves a selected document from the mass storage system, and displays the selected document on the large format display, where the list of matching documents includes an identification of at least one of the stored documents having at least one associated physical location substantially matching the determined location of the remote user terminal and where the selected document is selected from the generated list of matching documents. The positioning device can update the location of the remote user terminal and the remote user terminal accesses the mass storage system, reads the document information, generates a new list of matching documents, retrieves a new selected document from the mass storage system, and displays the new selected document on the large format display. The new list of matching documents can include an identification of the stored documents having at least one associated physical location substantially matching the updated location of the remote user terminal and the new selected document can be selected from the new list of matching documents. The document information can further include revision information associated with each document and the remote user terminal accesses the mass storage system, reads the revision information for the displayed selected document, and updates the displayed selected document if the revision information associated with the displayed selected document has changed. At least one updated portion of the displayed document can be identified by indicia. The indicia or identifying information from the remote user terminal can be used to assemble the list of matching documents. The mass storage system can further include at least one local mass storage device coupled to the remote user terminal and at least one remote mass storage device accessible by the remote user terminal. The system can further include a capture device that can select at least a portion of the displayed document to present to a user on the remote user terminal.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements. The word “exemplary” is used herein to mean “serving as an example, instance, or illustration.” Any embodiment or design described herein as “exemplary” is not necessarily to be construed as preferred or advantageous over other embodiments or designs.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of exemplary system in accordance with an embodiment of the invention.

FIG. 2 is an illustration of exemplary system with multiple users in accordance with an embodiment of the invention.

FIG. 3 is an exemplary process flow for displaying large format documents in accordance with an embodiment of the invention.

FIG. 4 is an exemplary process flow for displaying large format documents as location changes in accordance with an embodiment of the invention.

FIG. 5 is an exemplary process flow for updating the display of large format documents in accordance with an embodiment of the invention.

### DETAILED DESCRIPTION OF THE DRAWINGS

The invention disclosed herein provides for methods and systems for displaying large format documents on a remote large format display. Additionally, the invention disclosed herein provides for automating at least a portion of the document selection process, based on the location of the large format display. By at least partially automating the selection process, the invention addresses concerns of correctly selecting the appropriate document by automatically selecting the documents available by the location of the display or associated positioning device. The invention further addresses concerns in maintaining or having access to lists of identifiers for documents, as the proper document for a location is automatically retrieved based on the location of the display device or an associated positioning device.

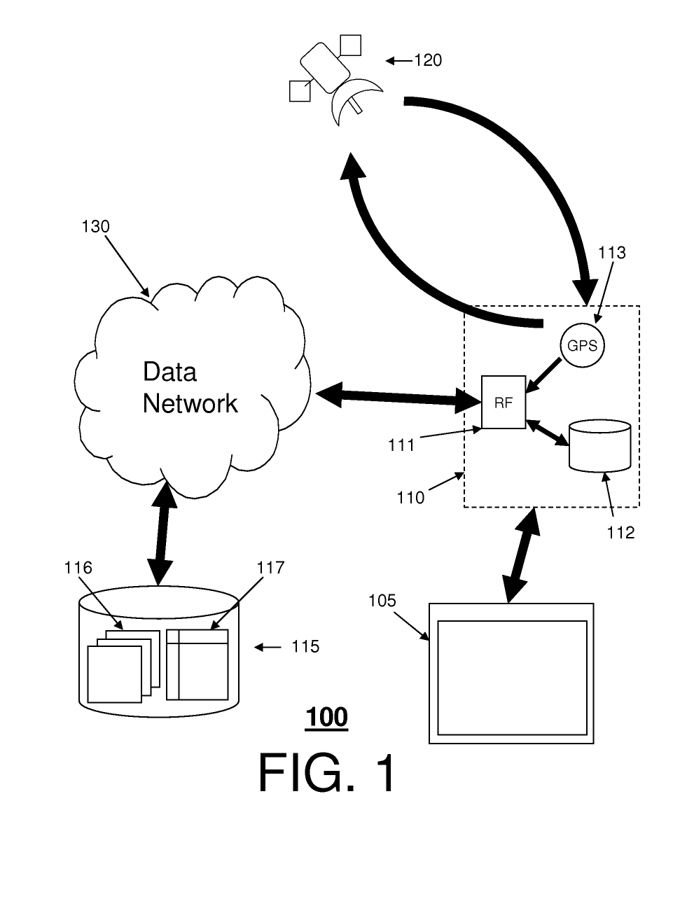

With reference now to the figures, FIG. 1 depicts a pictorial representation of a system 100 in accordance with an embodiment of the present invention. The large format display system comprises a large format display 105, a remote user terminal 110, and a mass storage system. Although the illustrated embodiment shows a separate remote user terminal 110 and large format display 105, it can be appreciated that the remote user terminal 110 and the large format display 105 can be configured to comprise a single unit.

In the various embodiments, the mass storage system can comprise at least one mass storage device for storing one or more documents 116 and document information. In the illustrated embodiment, the mass storage system comprises a remote server 115 accessible over a data network 130 by the remote user terminal 110. However, in some embodiments the mass storage system can also comprise a local mass storage 112 coupled directly to the remote user terminal 110. The server 115 can be used to store one or more documents 116 associated with one or more physical locations. In some embodiments, the server 115 can be used to house a document database 117 associating one or more physical locations with one or more stored documents 116 to be displayed on the large format display 105. In the various embodiments, the document database 117 may include, but is not limited to, document description information, document identifier information, and one or more locations associated with one or more of the stored documents 116. It can be appreciated that in some embodiments that document information may be stored in the document itself, rather than in a database.

In the various embodiments, the large format display 105 coupled to the remote user terminal 110 is a display adapted for displaying large format drawings and documents without obliterating any details of the documents, specifically with sufficient resolution to display details commonly visible on large format documents, such as single lines and annotations common on architectural drawings and construction plans. By way of example, not limitation, the large format display 105 in the illustrated embodiment can comprise a flexible display, adapted to display full size D-size or E-size blueprints and drawings, thus allowing the display to be rolled up or folded up for portability. However, in other embodiments, the large format display 105 could comprise any available large format, high resolution display, including but not limited to liquid crystal (LCD), plasma, projection, or cathode ray tube (CRT) display devices. Additionally, it can be appreciated that the large format display 105 need not be mobile and multiple displays could be located in multiple locations. In such embodiments of the system, a remote user terminal 110 would then display location appropriate content, on the large format display 105, based on the location of the remote user terminal 110 currently coupled to it. In the various embodiments, the large format display 105 can be coupled to the remote user terminal 110 directly using a cable or wirelessly using a Bluetooth-type or other wireless-type connection.

In the various embodiments, the remote user terminal 110 can comprise at least a communications system 111 and a positioning system 113. In some embodiments, as stated previously, the remote user terminal 110 can also comprise a mass storage system 11 2. In the various embodiments, the positioning system 11 3 can comprise any one of known positioning systems, including, but not limited to global positioning (GPS), triangulation schemes, inertial navigation, or radio frequency identification (RFID) systems. In some embodiments, the location can also be determined by the location of the connection to the data network 130, for example, the known location of a cellular tower or a local wireless network. In the illustrated embodiment, the positioning system 113 comprises a GPS system embedded into the remote user terminal 110. An example of such a system could be a GPS-enabled mobile phone device. In other embodiments, the remote user terminal 110 may comprise a GPS-enabled personal data assistant (PDA), personal computer, or any other similar device.

While the illustrated embodiment shows the positioning system 113 is embedded into the remote user terminal 110, it can be appreciated that a positioning system 113 could coupled externally to any type of remote user terminal 110. For example, a GPS system can be coupled to a laptop computer or PDA via an external data port of the remote user terminal 110. It can also be appreciated that the invention is not limited to utilizing a single type of positioning technology. In some embodiments, the positioning system 11 3 of the remote user terminal 110 may comprise of multiple types of positioning devices 11 3, allowing for the location of the remote user terminal 110 when a reference object 120 associated with a type of positioning device 113 is not available. In other embodiments, a combination of positioning devices 113 may be used to increase accuracy in determining the location of the remote user terminal 110, further reducing the amount of searching and selection to be done by the user.

For example, modern GPS systems do not provide or display elevation information. However, in the cases where users are viewing plans for a small structure or viewing a map, elevation information may not be critical. However in the case of documents involving multi-story structures, such as an apartment building, if the remote user terminal moves in an apartment building from one unit to an upstairs adjacent unit, the remote user terminal may not register a change in location and would therefore not bring up the document associated with the upstairs unit. However, when used in combination with another technology, such as RFID, the remote user terminal could use the secondary positioning device to sense the change in location, prompting the user to select a new document based on the new location. In some embodiments, the remote user terminal could be configured so that the secondary positioning device can remain inactive until needed. For example, in the case of a multi-story apartment building, for a given location two or more floor plans associated with individual units could be retrieved if relying solely on GPS. In the case of a high rise building or a hotel, this could mean dozens of units, each with several plans associated with the present location. In such cases, the remote user terminal could be configured to activate the secondary positioning device, such as RFID, indicating the floor of the building and automatically producing a much smaller and more manageable list of documents to choose from.

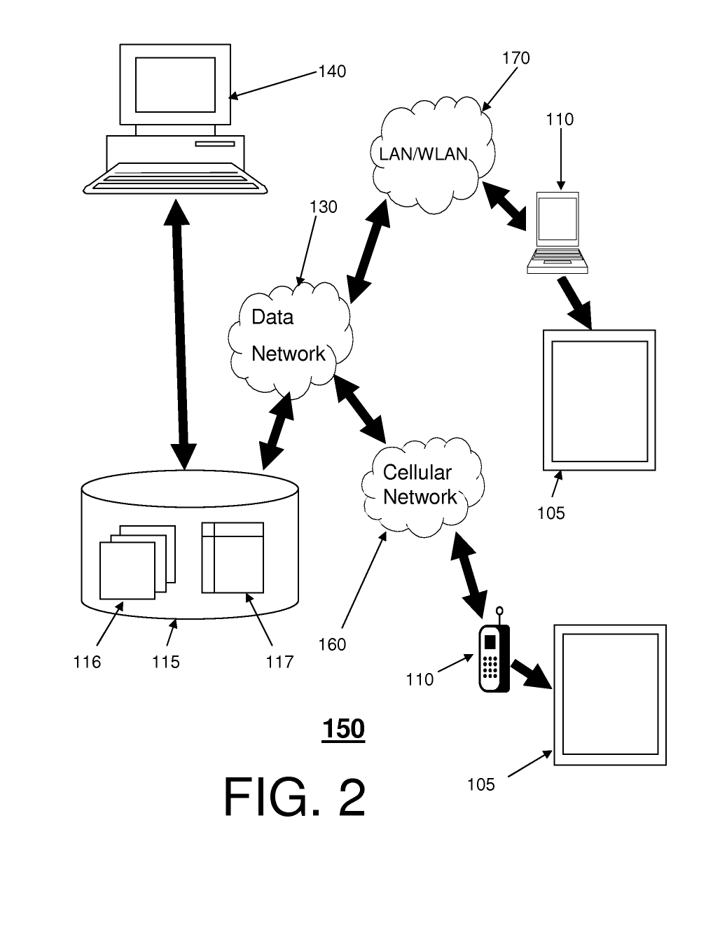

In various embodiments, the remote user terminal 110 can remotely or locally access the document database 117 or the stored documents 116 to be displayed. Embodiments in which the stored documents 116 or the document database 117 can be accessed locally can be advantageous, especially where data communications are difficult or slow. However, remote storage of the stored documents 116 or the document database 117 can be advantageous as well, since multiple users would be able the access the same file or group of files simultaneously, as shown in the system 150 of FIG. 2. Such embodiments can also be advantageous in that updated documents can be provided or be accessible to all users immediately. For example, in FIG. 2, an author or editor of a document working at a terminal 140 can update a stored document 116 located on the server. The author or editor might also update the entries in the document database 117. Therefore, when one or more remote user terminals 110, 110 access files on the server 11 5, whether through a cellular data network 160 or a wired or wireless local area network 170 with access to the data network 130 associated with the server 11 5, the remote user terminals 110, 110 can retrieve the most current versions of the stored documents 116 available. However, it can be appreciated that in some embodiments, a combination of local and remote mass storage devices can be used to optimize speed of retrieval and availability of updated documents by caching or storing at least a portion of the stored documents 11 6 and/or the document database 117 in the local mass storage 112 (see FIG. 1).

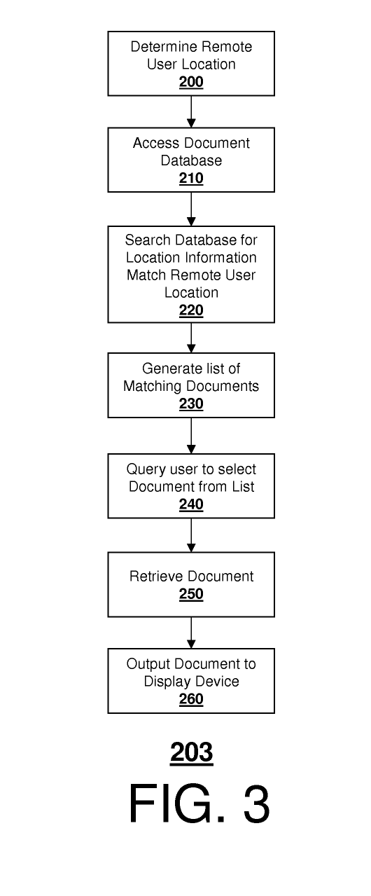

An exemplary process flow for a method 203 of the retrieval and display of a large format document in accordance with the present invention is shown in FIG. 3. First, upon arriving at a location or approaching a location, the remote user terminal 110 determines its position using a positioning system 113 at step 200. Once the remote terminal device 110 has determined its position, the remote user terminal accesses a document database at step 210. As previously discussed, the document database 117 may be stored on a remote mass storage system, such as a server 115 accessible over a data network 130, locally on a local mass storage device 112 coupled to the remote user terminal 110, or using a combination of locally and remotely stored files. Regardless of the location of the document database 117, once access has been established by the remote user terminal 110, the document database 117 may be searched or queried for location information associated with one or more stored documents 116 that substantially match the location of the remote user terminal 110 at step 220. Subsequently, a list of matching stored documents 116 found on the server 115 or the local mass storage device 112 is generated and provided to the remote user terminal 110 at step 230. A user is then queried to select one from the list of matching documents to output to the large format display 105 at step 240.

In some embodiments of the present invention, the list of matching documents presented to a specific user may be tailored or limited accordingly through the use of user profiles, passwords, or other identifying information, such as location or type or remote user terminal 110. In such embodiments, the list of accessible and/or modifiable documents may be limited; thus, only a partial list of documents matching the location of the remote user terminal 110 may be presented to the user. In other embodiments, the list of matching documents may be rearranged or assembled such that the documents that are likely most relevant to the user or associated with the user's profession or provided services are displayed at the top of the list presented to the user. For example, in one embodiment, when a user accesses plans for a construction site and is identified as an electrician, the user may be only allowed to view and/or modify only the electrical plans associated with the construction site. In another embodiment, an electrician user may have access to all plans for the construction site, but the remote user terminal 110 may present the list of matching documents with the electrical plans at the top.

Once the user has selected a document from the list, at step 250 the selected document is retrieved from its current location, the server 115 or the local mass storage device 112. In can be appreciated that in some embodiments where copies of documents are locally cached, a copy of the selected document stored on the local mass storage device 112 may be compared to the copy on the server 115, in order to retrieve the most recent version of a selected document. In the various embodiments, once the selected document is retrieved by the remote user terminal 110, the remote user terminal 110 outputs the contents of the selected document to the large format display device 105 coupled to the remote user terminal 110 at step 260.

In the various embodiments, in order to generate a list of matching stored documents, a location associated with a one or more stored documents 116 is considered to substantially match the location of the remote user terminal 110 if the location of the remote user terminal 110 is within a predetermined distance or tolerance of the location associated with a document. In some embodiments, the tolerance may be user specified via the remote user terminal 110. In other embodiments, the tolerance may be an additional entry in the document location database, whereby the list of matching documents generated in step 230 is generated by determining whether the location determined in step 200 is within the allowed tolerance for each document. It can be appreciated that in some embodiments, the tolerance for one or more stored documents 116 may vary, depending on the proximity of locations having one or more stored documents 116 associated with them. For example, an architect for a housing development may need to inspect various distinct and unrelated structures within a short distance, requiring a smaller tolerance. In another example, a larger tolerance could be allowed in larger structures, such as a supermarket or other large single story structure. It can also be appreciated that under certain circumstances a combination of large and small tolerances may be used to generate the list of matching items. For example, in an apartment building, a large tolerance may be used to generate a list that includes the master plan for the entire building, but a much smaller tolerance may be used to identify which unit the remote user terminal 110 is currently located in.

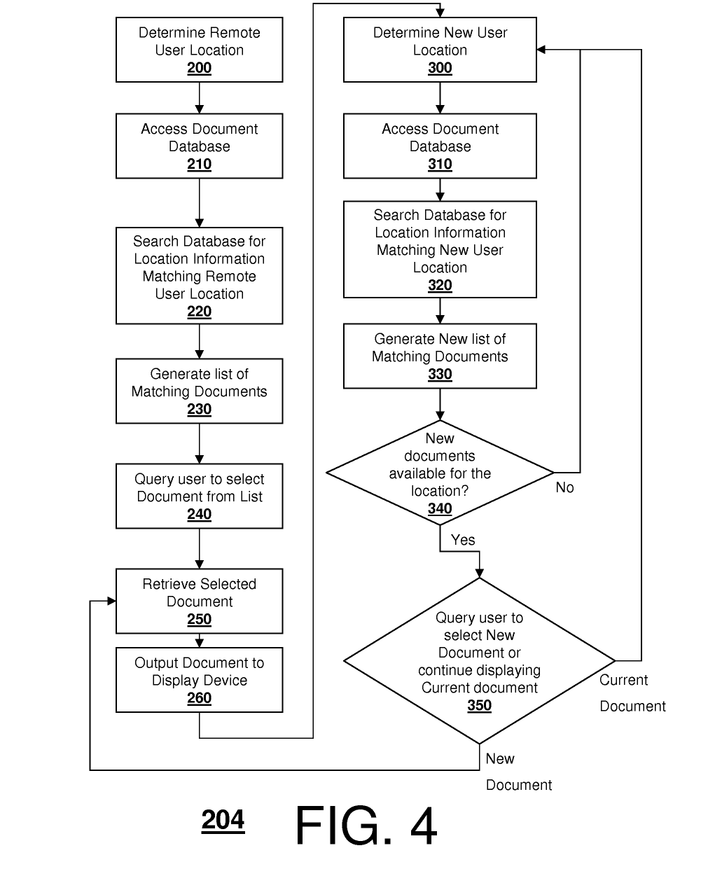

In some embodiments, it may be desired that the available and displayed documents be updated based on real-time changes in location. An exemplary process flow for another embodiment of a method 204 for the retrieval and display of a large format document, while monitoring the current location of the remote user terminal 110, in accordance with the present invention is shown in FIG. 4. In such embodiments, once the remote user terminal 110 has completed the steps of determining location and retrieving and displaying a document (steps 200-260), the remote user terminal 110 continues to monitor for changes in location and generates a new list of appropriate documents. First, the remote user terminal 110 newly determines location at step 300 and accesses the document database 117 to generate a new list of documents matching the newly determined location (steps 310-330).

In the illustrated flow in FIG. 4, if the list of documents available for the location has changed at decision step 340, the user, via the remote user terminal 110, is notified of the change in location, notified of available stored documents associated with the present location, and queried to select a new document or continue viewing the current document at decision step 340. If a new document is selected, the remote user terminal 110 retrieves the newly selected document at step 250 and displays this retrieved document on the large format display at step 260. Otherwise, the remote user terminal 110 continues to monitor for further changes in available stored documents 116 associated with the current location (steps 300, 310). Such an exemplary flow can enable immediate notification to a user not only of changes in location, but also of new documents associated with the current location currently being stored on the server 115.

In other embodiments, it may be desired that displayed document content be continually updated. This type of updating is advantageous when one or more stored documents 116 needs to be accessed by multiple remote terminals or when the document is evolving over time. In such embodiments, a change by the document author or editor can be immediately transmitted to current viewers of the document. In some embodiments the system may be configured to indicate any changes in the displayed document by drawing attention to the altered portion of the document via the use of indicia, including but not limited to inserted comments or by varying lettering, coloration, or patterning.

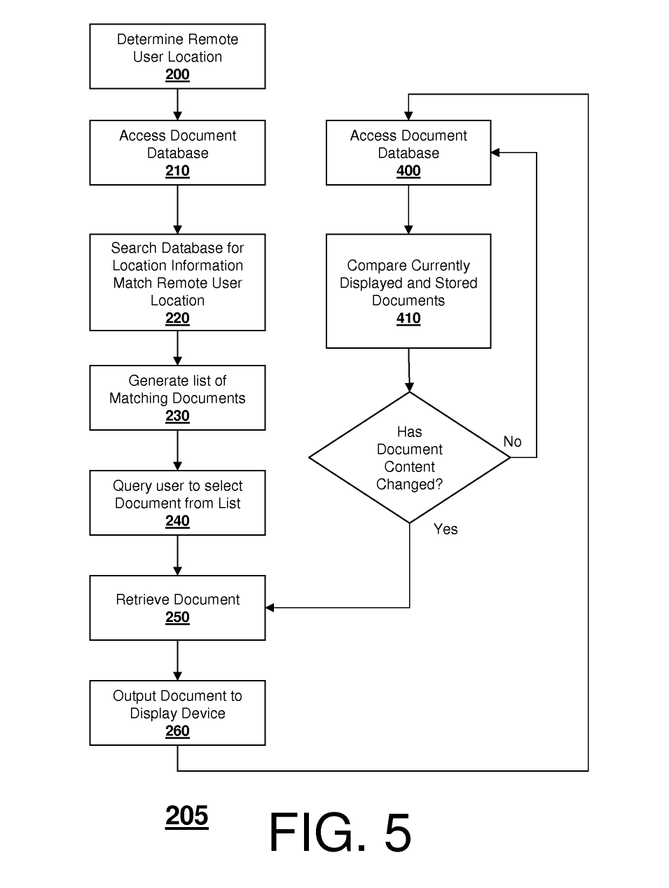

An exemplary process flow for an embodiment of a method 205 for the retrieval, display, and continual updating of a large format document in accordance with the present invention is shown in FIG. 5. In such embodiments, once the remote user terminal 110 has completed the steps of determining location and retrieving and displaying a document (steps 200-260 as discussed above), the remote user terminal 110 continues to monitor for changes in the stored document. First the remote user terminal 110 accesses the document database 117 and looks up any version information associated with the currently displayed document at step 400. Such version information may include, but is not limited to, the date the document was last modified or a stored version number for the document. Second, the version information for the currently displayed document and the currently stored document are compared for changes at step 410. If a new version of the document is available, then the document is newly retrieved and output to the display device 105 (steps 250, 260). If the document remains unchanged, then the remote user terminal 110 makes no changes to the display, and just continues to monitor for changes in the document (see steps 400, 410). In some embodiments, the user can be notified through the remote user terminal 110 of the new version of a document being available and the user can be prompted as to whether or not to open the new version of the document.

In various embodiments of the present invention, the system 100 can further comprise a capture device. The capture device can be used to select a portion of the document currently displayed on the large format display 105. This selected portion can then be displayed on the remote user terminal 110. In some embodiments, only the selected portion of the displayed document is available on the remote terminal device. In other embodiments, the remote user terminal 110 may be able to access the entire document, section by section while using the selected portion as a staring point. Such embodiments can be advantageous when only a portion of the document is needed, especially when using or carrying a large format display 105 becomes impractical.

For example, an electrician can initially select to display an electrical plan to find a section of interest he needs to work on. Afterwards, using the capture device, the electrician could select this section of interest to display on his PDA or other remote user terminal 110. The electrician could leave behind the large format display and only carry the PDA into the service crawl space. The electrician could then access the electrical drawings using his PDA, using the user interface of the PDA to browse or scroll the document as needed.

In some embodiments, the capture device can comprise a mouse, electronic pen, or other similar pointing device which allows the user to select and highlight a portion of the document to be displayed on the remote user terminal 110.

In other embodiments, the capture module can comprise an imaging device. In such embodiments, the imaging device can be configured to capture an image of a portion of the document displayed on the large format display 105. In some embodiments, only the captured image would be displayed on the remote user terminal 110. In other embodiments, the captured image can be compared to the document displayed on the large format display 105 to identify the portion captured by the imager. Afterwards, the identified portion of the document can be displayed on the remote user terminal 110. As previously described, only a portion of the document may be displayed. But in other embodiments, the remote user terminal 110 may be able to access the entire document, section by section while using the selected portion as a staring point.

In light of the foregoing description, it should be recognized that embodiments in accordance with the present invention can be realized in hardware, software, or a combination of hardware and software. A data network or server according to the present invention can be realized in a centralized fashion in one computer system or processor or in a distributed fashion where different elements are spread across several interconnected computer systems or processors. Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

We claim:

1. A method for using electronic large format location dependent documents, the method comprising the steps of:
determining a location of a remote user terminal;
accessing a mass storage system using the remote user terminal, the mass storage system having stored therein one or more documents, wherein at least one physical location is associated with each one of the stored documents;
generating a list of matching documents, wherein the list of matching documents comprises an identification of the stored documents stored having at least one physical location substantially matching the determined location of the remote user terminal; and
retrieving a selected document from the mass storage system and displaying the selected document on a large format display coupled to the remote user terminal, wherein the selected document is selected from the generated list of matching documents.

2. The method of claim 1, the method further comprising the step of:
updating the location of the remote user terminal and repeating the steps of accessing, generating, retrieving, and displaying if the location of the remote terminal device has changed.

3. The method of claim 1, wherein revision information is associated with each one of the stored documents and the method further comprises the step of accessing the mass storage system, retrieving and analyzing revision information associated with the selected document, and updating the displayed selected document if revision information associated with the displayed selected document has changed.

4. The method of claim 3, wherein the step of updating further comprises the step of providing indicia to identify at least one updated portion of the displayed selected document.

5. The method of claim 1, wherein the remote user terminal comprises a wireless communication device.

6. The method of claim 1, wherein the large format display further comprises a flexible display device.

7. The method of claim 1, wherein the mass storage system further comprises at least one local mass storage device coupled to the remote user terminal and at least one remote mass storage device accessible by the remote user terminal.

8. A system for using electronic large format location dependent documents, the system comprising:
a remote user terminal having access to a mass storage system, the remote user terminal having a positioning device, wherein the positioning device determines a location of the remote user terminal and wherein the mass storage system has stored therein one or more documents having associated document information, wherein the document information comprises at least one physical location associated with each one of the stored documents;
a large format display coupled to the remote user terminal,
wherein the remote user terminal accesses the mass storage system, reads the document information, generates a list of matching documents, retrieves a selected document from the mass storage system, and displays the selected document on the large format display, wherein the list of matching documents comprises an identification of at least one of the stored documents having at least one associated physical location substantially matching the determined location of the remote user terminal, wherein the selected document is selected from the generated list of matching documents.

9. The system of claim 8, wherein the positioning device updates the location of the remote user terminal, wherein the remote user terminal accesses the mass storage system, reads the document information, generates a new list of matching documents, retrieves a new selected document from the mass storage system, and displays the new selected document on the large format display, wherein the new list of matching documents comprises an identification of the stored documents having at least one associated physical location substantially matching the updated location of the remote user terminal, wherein the new selected document is selected from the new list of matching documents.

10. The system of claim 8, wherein the document information further comprises revision information associated with each document and the remote user terminal accesses the mass storage system, reads the revision information for the displayed selected document, and updates the displayed selected document if the revision information associated with the displayed selected document has changed.

11. The system of claim 10, wherein at least one updated portion of the displayed document is identified by indicia.

12. The system of claim 8, wherein the remote user terminal further comprises a wireless communication device.

13. The system of claim 8, wherein the large format display further comprises a flexible display device.

14. The system of claim 8, wherein the mass storage system further comprises at least one local mass storage device coupled to the remote user terminal and at least one remote mass storage device accessible by the remote user terminal.

15. The system of claim 8, wherein identifying information from the remote user terminal is used to assemble the list of matching documents.

16. The system of claim 8, further comprising a capture device, wherein the capture device selects at least a portion of the displayed document to present to a user on the remote user terminal.

17. A machine readable storage, having stored thereon a computer program having a plurality of code sections executable by a machine for causing the machine to perform the steps of:
storing a one or more documents in a mass storage system;
storing a document database in the mass storage system, the document database comprising of document information associated with the stored documents, wherein the document information further comprises at least one physical location associated with each document and revision information associated with each document;
determining a location of a remote user terminal having access to the mass storage system;
accessing the mass storage system, searching the document database, and generating a list of matching documents, wherein the list of matching documents comprises an identification of each one of the stored documents having at least one associated physical location substantially matching the determined location of the remote user terminal; and
retrieving a selected document from the mass storage device system and displaying the selected document on a large format display coupled to the remote user terminal, wherein the selected document is selected from the generated list of matching documents.

18. The machine readable storage of claim 17, the machine readable storage further includes a plurality of code sections executable by the machine for causing the machine to update the location of the remote user terminal and repeating the steps of accessing, searching, generating, retrieving, and displaying if the location of the remote terminal device has changed.

19. The machine readable storage of claim 17, the machine readable storage further includes a plurality of code sections executable by the machine for causing the machine to access the mass storage system, search the document database for document information associated with displayed selected document, analyze revision information associated with the selected document, and update the displayed selected document if revision information associated with the displayed selected document has changed.

20. The machine readable storage of claim 17, wherein the machine readable storage further includes a plurality of code sections executable by the machine for causing the machine to provide indicia to identify at least one updated portion of the displayed selected document.
